(19) United States
(12) Patent Application Publication
(10) Pub. No.: US 2021/0248481 A1
(43) Pub. Date: Aug. 12, 2021

(54) Data Processing System and Data Processing Method

(71) Applicant: Hitachi, Ltd., Tokyo (JP)

(72) Inventors: Tohru WATANABE, Tokyo (JP); Masato UTSUMI, Tokyo (JP); Ikuo SHIGEMORI, Tokyo (JP); Tetsu ITO, Tokyo (JP); Jun YAMAZAKI, Tokyo (JP); Daisuke HAMABA, Tokyo (JP); Hiroshi IIMURA, Tokyo (JP)

(21) Appl. No.: 16/951,088

(22) Filed: Nov. 18, 2020

(30) Foreign Application Priority Data
Feb. 12, 2020 (JP) 2020-021959

(51) Int. Cl. G06N 5/00; G06K 9/62; G06Q 30/02

(52) U.S. Cl. CPC G06N 5/003; G06Q 30/0202; G06K 9/6256

(57) ABSTRACT

An object of the invention is to provide a data processing system that can appropriately determine data to be used for identification of a prediction model. The data processing system that performs prediction using a prediction model, includes: a selection unit that selects data to be used for identification of a prediction model from a storage unit that stores data; and a processing unit that identifies the prediction model by using the data selected by the selection unit. The selection unit selects, from the storage unit, predetermined first data, and second data of a type and/or condition different from the first data, based on a branch condition of structure data of a structural prediction model.

### BACKGROUND OF THE INVENTION

### 1. Field of the Invention

The present invention relates to a data processing system and a data processing method, and is suitable for application to, for example, a data processing system and a data processing method for performing prediction using a prediction model.

### 2. Description of the Related Art

In an energy business field including an electric power business, a gas business and the like, a communication business field, a transportation business field including taxi service, delivery service and the like, and the like, a future demand amount, a settlement price, and the like are predicted in order to perform facility operation, resource allocation, and the like in accordance with a demand of a consumer.

For example, in order to plan supply with respect to a demand for electric power which fluctuates by day or hour, prediction for a value (amount of electric power to be consumed) of the demand at a specified time such as one hour, two hours, three hours, the next day, one week, one month or one year in the future, and prediction for a value of an amount of electric power to be generated by a wind power generator, a solar power generator, or the like are performed.

In analysis and/or prediction of phenomena of energy such as electric power and gas, an error may occur. Therefore, an analysis limit is assumed, and reduction of an error in analysis and/or prediction is performed.

As a device that predicts a demand with a higher accuracy, a demand predicting device has been disclosed, including: a first prediction determination unit that determines first prediction data indicating a predicted value of a demand, based on forecast data containing a predicted value of predetermined information and based on first record data containing a result value of the demand; and a second prediction determination unit that, when the first prediction data satisfies a predetermined condition, determines second prediction data indicating another predicted value of the demand, based on the first record data and based on second record data containing a record value of the predetermined information (see JP-A-2019-117601).

Here, accuracy of prediction increases in the order of multiple regression prediction, Bayes optimal prediction using a decision tree model, prediction using a Gaussian process regression that reproduces a Gaussian process derived from a probability function. Further, as accuracy of a probability model which is incorporated increases, the accuracy of prediction increases.

However, in a case where prediction using Gaussian process regression is adopted in the demand predicting device described in PTL 1, since memory is consumed by the square of the number of samples N to derive a probability model, there is no choice but to shorten a sampling period and data of samples for a rare frequency event (temperature specific day, power generation plan stop, fuel transportation surplus, and the like) may be lost.

### SUMMARY OF THE INVENTION

The invention has been made in view of the above circumstances, and an object of the invention is to propose a data processing system or the like that can appropriately determine data to be used for identification of a prediction model.

In order to solve such a problem, the invention provides a data processing system that performs prediction using a prediction model and that includes: a selection unit configured to select data to be used for identification of a prediction model from a storage unit that stores data; and a processing unit configured to identify the prediction model by using the data selected by the selection unit. The selection unit selects, from the storage unit, predetermined first data, and second data of a type and/or condition different from the first data, based on a branch condition of structure data of a structural prediction model.

With the above configuration, for example, the predetermined first data, and the second data of a type and/or condition different from the first data, are used for identification of the prediction model, and highly accurate prediction which incorporates a causal relationship that is lacking in the predetermined first data is realized. With the above configuration, since it is possible to avoid a situation where data of a rare frequency event is omitted from the data used for identification of the prediction model, it is possible to reduce consumption of the memory and improve accuracy of prediction, for example, by adopting a prediction model using the kernel function to shorten a sampling period.

According to the invention, it is possible to appropriately determine data used for identification of a prediction model.

### BRIEF DESCRIPTION OF THE DRAWINGS

FIG. 1 is a diagram illustrating a configuration example of a data processing system according to a first embodiment.

FIG. 2 is a diagram illustrating a configuration example of a data analysis and prediction system according to the first embodiment.

FIG. 3 is a block diagram illustrating a flow of data in the data analysis and prediction system according to the first embodiment.

FIG. 4 is a diagram illustrating an example of a flowchart relating to data analysis prediction processing according to the first embodiment.

FIG. 5 is a diagram illustrating an example of a flowchart relating to observation time-series data clustering processing according to the first embodiment.

FIG. 6 is a diagram illustrating an example of a flowchart relating to data and index selection processing according to the first embodiment.

FIG. 7 is a diagram illustrating an example of an intermediate result of the observation time-series data clustering processing according to the first embodiment.

FIG. 8 is a diagram illustrating an example of a processing result by a decision tree model generation unit according to the first embodiment.

FIG. 9 is a diagram illustrating an example of a table in which importance degrees and ordinal numbers, of predictors, according to the first embodiment are stored.

FIG. 10 is a diagram illustrating an example of a table holding training data used for identification of a prediction model according to the first embodiment.

FIG. 11 is a diagram illustrating an example of a superimposition graph according to the first embodiment.

FIG. 12 is a diagram illustrating an example of a power generation prediction control system that uses a data predicting method according to the first embodiment.

### DESCRIPTION OF THE PREFERRED EMBODIMENTS

Hereinafter, an embodiment of the invention will be described in detail with reference to the drawings. The present embodiment relates to a technique for predicting data. A configuration shown in the present embodiment is suitable for application to an operation support system for energy such as electric power, gas, or fuel.

For example, a system according to the present embodiment is a system that can analyze and/or predict a model (regression equation, self-regression equation, mapping, probability map) between data of prediction target and data of explanatory variable. More specifically, the system performs prediction, and includes a structure analysis unit that uses a structural prediction model to predict (classify), with an explanatory variable (or predictor, input data), data of a prediction target (or prediction output, prediction value, prediction data, output data), a first prediction unit that performs prediction based on a prediction model (explanatory variable and regression, or mathematical formula), and a determination unit that determines, based on output from the structure analysis unit, an index, such as a type of the explanatory variable and a period and location added to the explanatory variable, which are to be transferred to the first prediction unit.

Specifically, the structural prediction model is a network structure, and more specifically, a tree structure. Specifically, the prediction model is a prediction model using a kernel function, and more specifically, a prediction model using Gaussian process regression.

### (1) FIRST EMBODIMENT

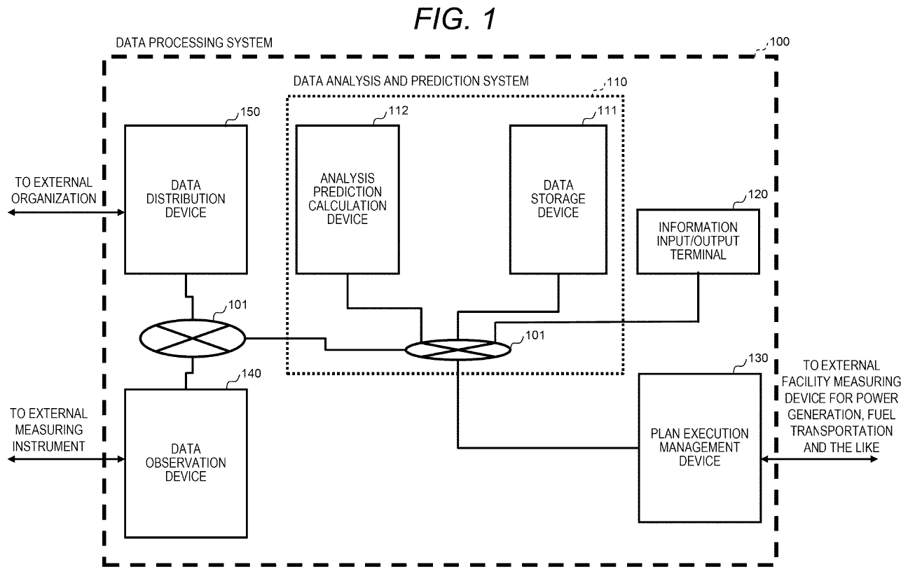

FIG. 1 illustrates a data processing system 100 as a whole according to a first embodiment.

FIG. 1 is a diagram illustrating a configuration example of the data processing system 100.

The data processing system 100 illustrated in FIG. 1 can be suitably adopted in the electric power business field. In this case, the data processing system 100 predicts an electric power demand amount for a predetermined period in the future based on observation data and/or distribution data. Alternatively, the data processing system 100 predicts a power generation market settlement price of electric power for a predetermined period in the future, based on a record amount of power generation market settlement price of electric power in the past.

Here, a purpose of data processing is to analyze a quantitative relationship behind data that is called input and output, estimate, regress, and restore a relationship statistically, identify a structure of the relationship, and estimate output data paired with new input data based on the relationship. In general, when the output data is a value for a future time point, estimation of the output data is referred to as prediction. In particular, if not limited, it may be referred to as estimation, in addition to prediction.

Based on a prediction result, a power company enables smooth power supply and demand management. Some power company can accurately formulate and execute a generator operation plan for its own facility. In addition, the power company can accurately formulate and execute a power procurement transaction plan that entrusts power generation to other power companies.

The data processing system 100 includes a data analysis and prediction system 110, an information input/output terminal 120, a plan execution management device 130, a data observation device 140, and a data distribution device 150. The data analysis and prediction system 110, the information input/output terminal 120, the plan execution management device 130, the data observation device 140, and the data distribution device 150 are communicably connected via a communication path 101.

The communication path 101 is, for example, a local area network (LAN) or a wide area network (WAN). Alternatively, the communication path 101 may be another form as long as various devices and terminals constituting the data processing system 100 can be communicably connected to each other.

The data analysis and prediction system 110 includes a data storage device 111 and an analysis prediction calculation device 112.

The data storage device 111 can store data that constitutes an input and data of a prediction target which constitutes an output. The data constituting an input is observation data, distribution data, index data to data, and the like.

The data storage device 111 provides data for processing of analyzing a relationship between input data and output data and/or processing of estimating (or predicting) an output. Input data and output data provided for processing of analysis and/or estimation, or data to be recorded in preparation for provision to processing is referred to as “sample data”.

The data storage device 111 has a configuration in which a setting input including a storage range of the sample data can be received from the information input/output terminal 120. Data stored or output by the data analysis and prediction system 110 can also be displayed on the information input/output terminal 120.

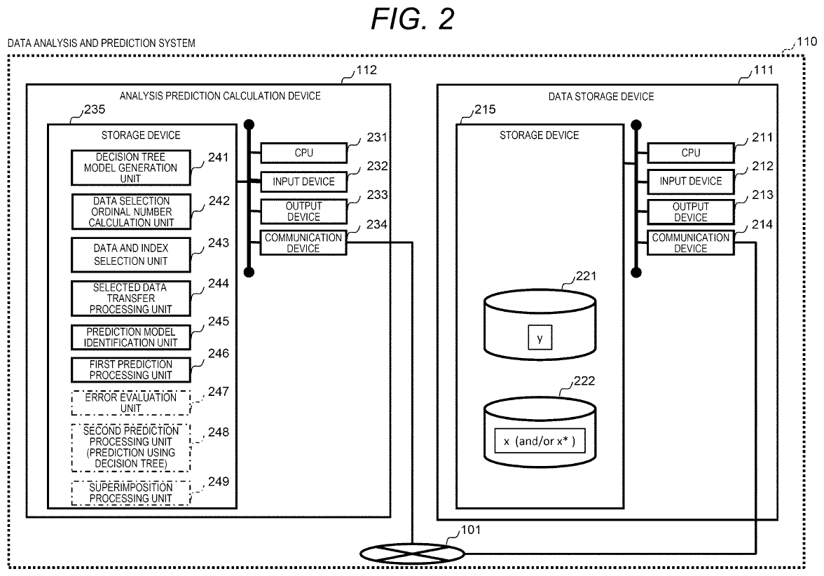

As will be described later with reference to FIG. 2, the analysis prediction calculation device 112 performs analysis processing of obtaining a relationship between an input and an output based on the sample data, and calculates data (output) of prediction target based on this relationship.

The information input/output terminal 120 has a function of inputting settings to the data storage device 111, the analysis prediction calculation device 112, and the plan execution management device 130.

Based on the output calculated by the analysis prediction calculation device 112, the plan execution management device 130 generates and executes a physical facility operation plan for achieving a predetermined target. Here, in the energy field, the physical facility operation plan is, for example, a generator operation plan that satisfies a predicted future energy demand value, or satisfies an energy demand plan value which is generated based on the predicted future energy demand value. The operation plan may include a plan value of a power generation amount to be entrusted to a generator of another power company.

The data observation device 140 periodically measures a prediction target (not shown) and transmits measurement data to at least one of the data storage device 111 and the analysis prediction calculation device 112. The measurement data includes data of a measuring instrument for measuring power consumption, data of a power generation end meter which is a power generation amount of a generator connected to a power transmission line, data of a power generation market settlement price, and the like.

The data distribution device 150 receives data from the outside of the data processing system 100, and transmits the data to at least one of the data storage device 111 and the analysis prediction calculation device 112. In order to receive data, the data distribution device 150 is connected to at least one of the following devices all of which are not illustrated: a weather observation device and a numerical weather forecasting device, a weather measuring device disposed on a power transmission line (which measures weather data of temperature and water vapor content), a current measuring device for a power transmission line, a management device for a large demand facility, a management device for a power transaction market, a management device for a fuel transaction market, a management device for a charter business, a management device for a railroad business facility, and a management device for a commuting business facility. The weather observation device and the numerical weather forecasting device may be installed in a weather organization such as a weather company or a meteorological agency.

The data distribution device 150 receives at least one type of past weather record data, numerical weather forecast data, power transmission current data, operating data of a large demand facility, power transaction data, fuel transaction data, operating data of a charter for fuel transportation or the like, operating data for a railway business, and operating data of a communication business facility.

Further, the data distribution device 150 is connected to a data distribution device in a police station, a fire station, or a news medium such as a newspaper company, and receives data of events such as disasters, accidents, and amusement that are transmitted from these institutions.

The prediction target (output) of the data processing system 100 includes, for example, energy consumption data for power, gas, water and the like, data of energy production amount by solar power generation, wind power generation and the like, and, as an example, a transaction amount of energy and a power generation market settlement price that are traded at Japan Electric Power Exchange (JEPX).

Examples of the input include weather data such as temperature, humidity, solar radiation amount, wind speed, and atmospheric pressure, calendar date data of a flag value indicating the type of day arbitrarily set, such as date, or day of week, and data indicating the presence or absence of an unexpected incident such as a typhoon or an event.

In addition to these, the input also includes: data indicating an economic situation including the number of energy consumers, industrial trends, business condition indexes, and the like; data indicating vehicle occupancy, number of vehicle passengers, number of booked seats of a limited express train, or a move situation of a human, a moving body and the like, such as a road traffic condition; and data of free on board (FOB) prices, delivered ex ship (DES) prices, forward expiration month prices and the like for fuels such as crude oil, natural gas, and petroleum.

### (Specific Configuration of Data Analysis Prediction System)

FIG. 2 is a diagram illustrating a configuration example of the data analysis and prediction system 110. FIG. 2 illustrates an example of a hardware configuration and a functional configuration of the data storage device 111 and a hardware configuration and a functional configuration of the analysis prediction calculation device 112, which constitute the data analysis and prediction system 110.

The data storage device 111 includes a central processing unit (CPU) 211, an input device 212, an output device 213, a communication device 214, and a storage device 215. The data storage device 111 is, for example, a data processing device such as a personal computer, a server computer, or a handheld computer.

The CPU 211 integrally controls operations of the data storage device 111. The input device 212 is a keyboard, a mouse, or the like. The output device 213 is a display, a printer, or the like. The communication device 214 includes a network interface card (NIC) for connecting to a wireless LAN or a wired LAN. The storage device 215 is a storage medium such as a random access memory (RAM), a read only memory (ROM), or a hard disk drive. The data storage device 111 may appropriately output an output result and an intermediate result of each processing unit via the output device 213.

In the storage device 215, databases of an observation data storage unit 221 and a distribution data storage unit 222 are stored.

In the observation data storage unit 221, a prediction target received from the data observation device 140 is periodically measured, and an index t (t is a vector when a plurality of pieces of information are to be indexed) for searching, such as a time point at which a value of measurement data y is observed and a location where the value of measurement data y is observed, is held. This held data is referred to as an output y(t).

In the distribution data storage unit 222, data received from the data distribution device 150 such as past weather record data, numerical weather forecast data, power transmission current data, operating data of a large demand facility, power transaction data, fuel transaction data, operating data of a charter for fuel transportation or the like, operating data for a railway business, and operating data of a communication business facility is held, with indexes t for searching names, generation time points, generation locations, and the like thereof added. This held data is referred to as an input x(t). Particularly, when x(t) is data of future prediction like numerical weather forecast data, it may be referred to as input x*(t). Particularly, the data may be referred to as “prediction input x*(t)” and data of future prediction.

The data analysis and prediction system 110 holds a record value y of the prediction target in the observation data storage unit 221, and outputs estimated data y*, which is a future value of the prediction target. The record value y of the prediction target is, for example, an output of a power demand measuring system for a power transmission line of the Kanto area, an output of a system that determines a sum of measuring instruments for a designated customer, and an output of a power generation market settlement price determining system. Since the data y* corresponds to an output of a device and a system in the background of the prediction target, the data y* may be referred to as data of output, output data, or simply output. The area includes a plurality of areas, such as Kanto area, Kansai area, and Hokkaido area. The data analysis and prediction system 110 can hold a record value y of the prediction target for each area, and perform processing of outputting the estimated data y* which is a future value.

The analysis prediction calculation device 112 includes a CPU 231, an input device 232, an output device 233, a communication device 234, and a storage device 235. The analysis prediction calculation device 112 is, for example, a data processing device such as a personal computer, a server computer, or a handheld computer. The CPU 231, the input device 232, the output device 233, the communication device 234, and the storage device 235 are basically the same as the CPU 211, the input device 212, the output device 213, the communication device 214, and the storage device 215.

In the storage device 235, various computer programs for a decision tree model generation unit 241, a data selection ordinal number calculation unit 242, a data and index selection unit 243, a selected data transfer processing unit 244, a prediction model identification unit 245, and a first prediction processing unit 246 are stored.

In addition, a computer program for an error evaluation unit 247 may be stored in the storage device 235. For example, feeding-back from the error evaluation unit 247 to the data and index selection unit 243 is performed.

In addition, various computer programs for a second prediction processing unit 248 and a superimposition processing unit 249 may be stored in the storage device 235. According to the second prediction processing unit 248 and the superimposition processing unit 249, for example, an output of prediction using n pieces of data for the whole year is compared with an output of precision prediction (prediction unit) in a short-term model using the latest n′ (<n) pieces of data, and if a gap therebetween is large, it can be detected that folding is insufficient in the short-term model.

The analysis prediction calculation device 112 may appropriately output an output result, an intermediate result and the like of each processing unit via the output device 233.

### (Content of Processing in Data Analysis Prediction System)

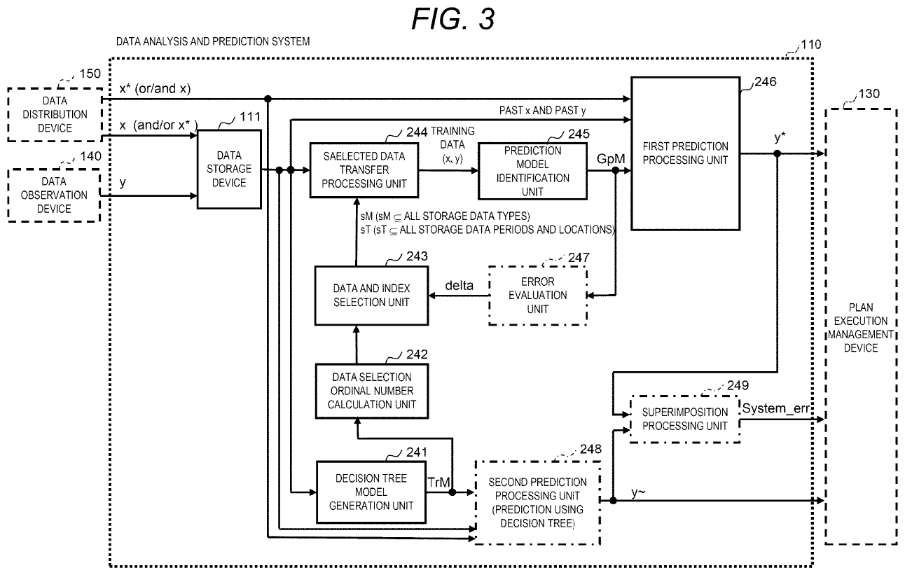

Processing and a data flow of the data analysis and prediction system 110 will be described with reference to FIGS. 3 to 11.

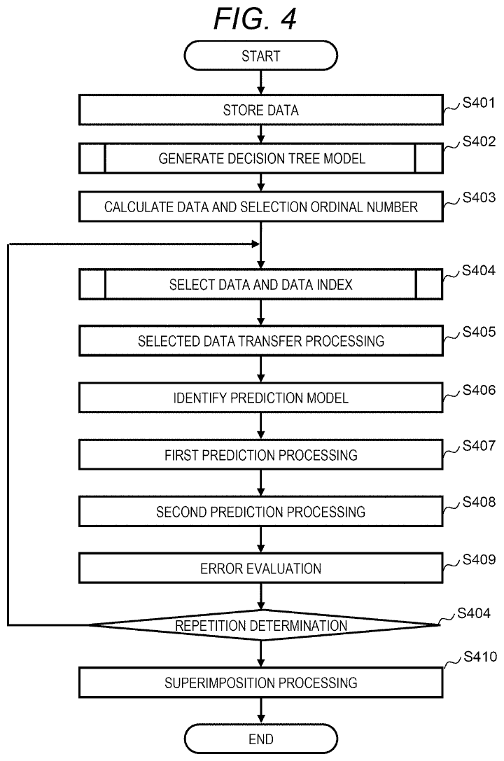

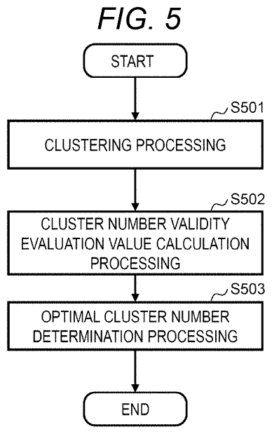

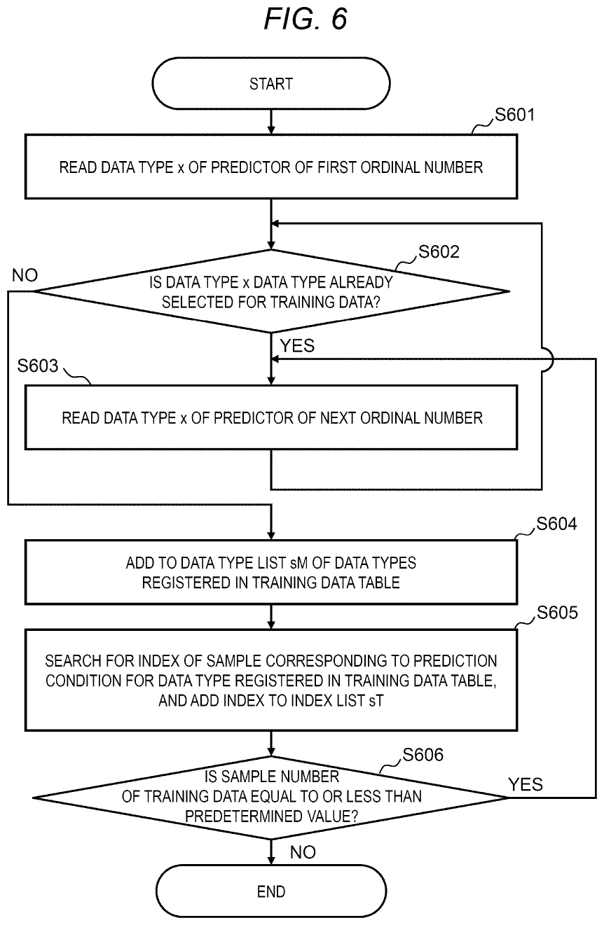

FIG. 3 is a block diagram illustrating a flow of data (signals) in the data analysis and prediction system 110. Processing of each processing unit in FIG. 3 is executed as a step in FIG. 4 showing a code number. Details of step S402 in FIG. 4 will be described with reference to FIG. 5, and details of step S404 in FIG. 4 will be described with reference to FIG. 6.

FIG. 4 is a diagram illustrating an example of a flowchart relating to processing (data analysis prediction processing) performed by the data analysis and prediction system 110. The data analysis prediction processing starts with at least one of reception of an input operation from a user by the analysis prediction calculation device 112 and arrival of an execution time point set in advance via the information input/output terminal 120.

### (Step S401)

The data storage device 111 receives, from data distribution device 150, data of “input x” and/or data of “input x*” that is a prediction value for an input, and stores the data in the distribution data storage unit 222. The data storage device 111 receives data of “output y” from the data observation device 140 and stores the data in the observation data storage unit 221.

### (Step S402)

In the decision tree model generation unit 241, the analysis prediction calculation device 112 generates a decision tree model based on data in the observation data storage unit 221 and data in the distribution data storage unit 222. The decision tree model is a method of automatically extracting meaningful data classification rules such as regularity and relevance from a large amount of data.

The decision tree model generation unit 241 generates a decision tree model in which a classification target is taken as a discrete value. First, the decision tree model generation unit 241 collects the data of the prediction target in the observation data storage unit 221 as time-series data of a predetermined time length (for example, 24 hours, 12 hours, or 6 hours) (the data is referred to as “observation time-series data”), and discretizes the observation time-series data by clustering processing, in which a frequency spectrum is taken as a feature quantity, in accordance with a procedure of the flowchart of FIG. 5.

FIG. 5 is a diagram illustrating an example of a flowchart relating to processing (observation time-series data clustering processing) executed by the decision tree model generation unit 241. The observation time-series data clustering processing is processing in which feature quantities such as an outline of observation time-series data in each area are classified into several similar clusters (demand patterns), and cluster centers are calculated as information representing each cluster. When the observation time-series data and attribute information of each area are given, the decision tree model generation unit 241 starts the observation time-series data clustering processing.

### (Step S501)

When the acquired observation time-series data is classified into 1 to M clusters, the decision tree model generation unit 241 determines a cluster center set {Ck: k=1, 2, . . . N} of the clusters (where N is any value from 1 to M). A theoretical maximum of M is the total number of the observation time series, but M may be limited to the following values for the sake of simplicity.

More specifically, when such observation time-series data is classified into one cluster, a cluster center set of the cluster is {C₁}, when such observation time-series data is classified into two clusters, a cluster center set of the clusters is {C₁, C₂}, and when such observation time-series data is classified into three clusters, a cluster center set of the clusters is {C₁, C₂, C₃} . . . . As described above, while changing the number of clusters N from 1 to M, the decision tree model generation unit 241 divides the observation time-series data into clusters, and determines a cluster center set {C₁, C₂, C₃, . . . , C_{N}} of the corresponding number of clusters using a k-means method. {C₁, C₂, C₃, . . . , C_{N}} may be referred to as {Cₖ} (k∈{1, 2, . . . , N}.

### (Step S502)

The decision tree model generation unit 241 executes cluster number validity evaluation value calculation processing of calculating an index (hereinafter, referred to as a “validity evaluation value”) that is for evaluating which cluster number N is appropriate based on a processing result of the clustering processing described above. In the case of the present embodiment, the decision tree model generation unit 241 calculates, as such validity evaluation value, an intra-cluster matching degree representing a cohesion degree of observation time-series data in each cluster, and an inter-cluster average separation degree representing a degree of separation between clusters.

### (Step S503)

The decision tree model generation unit 241 determines an optimal number of clusters based on the intra-cluster matching degree and the inter-cluster average separation degree that are calculated in step S502.

With the above processing, the observation time-series data is classified into an appropriate number of clusters. Note that a technique disclosed in WO 2015/133635 can be appropriately incorporated into steps S501 to S503.

The decision tree model generation unit 241 assigns a cluster ID to a “leaf” of a cluster set of discretized observation time-series data.

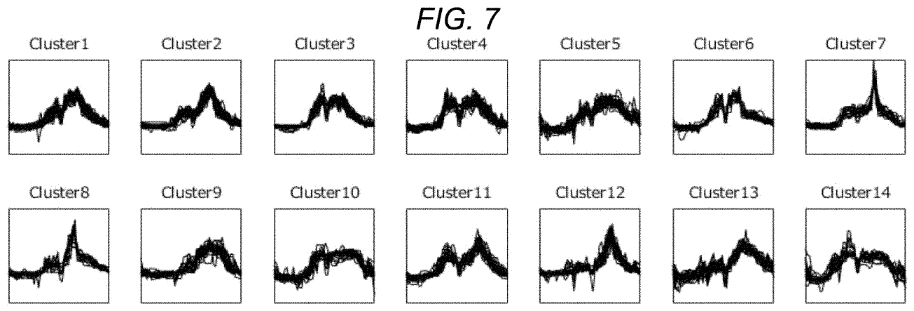

FIG. 7 is a diagram illustrating an example of an intermediate result of the observation time-series data clustering processing. Here, the number of clusters obtained by classifying the observation time-series data into groups according to closeness to the feature quantity is 14. The decision tree model generation unit 241 assigns a unique number (cluster ID) to a generated group, and assigns a cluster ID to each piece of the observation time-series data.

Next, the decision tree model generation unit 241 takes the cluster IDs of the observation time-series data as teacher data, and generates a decision tree model for classifying the observation time-series data. More specifically, the decision tree model generation unit 241 takes data in the distribution data storage unit 222 as a predictor (branch condition), and generates a decision tree model TrM for classifying observation time-series data by using an algorithm for generating a decision tree model.

As an algorithm for generating a decision tree model, known classification and regiterator trees (CART) are generally used. In addition, an algorithm such as iterative dichotomiser 3 (ID3) or chi-squared automatic interaction detection (CHAID) may be used.

The decision tree model generation unit 241 generates, for example, a decision tree model in which a factor that is more dominant to determine a prediction target appears in a “branch” which is a branch located upstream. In other words, a branch identifying an output corresponds to an explanatory variable.

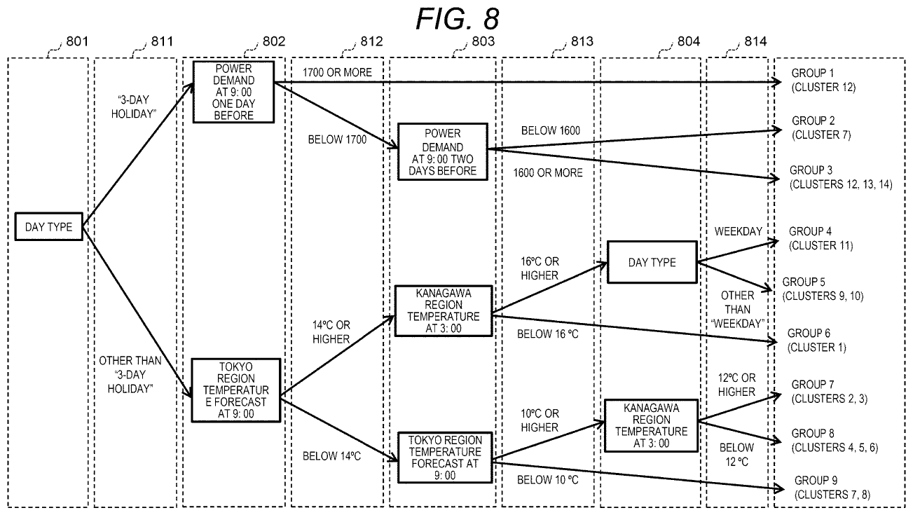

FIG. 8 is a diagram illustrating an example of a processing result by the decision tree model generation unit 241. The leaf of the decision tree model is displayed as a cluster ID. Each piece of the observation time-series data is classified according to both a predictor that is a branch condition of the decision tree model, and a numerical condition of the predictor. The predictor is, for example, a variable of a part that is distribution data surrounded by frames of a predictor display 801, a predictor display 802, a predictor display 803, and a predictor display 804 in FIG. 8. The numerical condition of a predictor is, for example, a magnitude relation of variables surrounded by frames of a condition display 811, a condition display 812, a condition display 813, and a condition indication 814, or a value of the observation data used for determination of correspondence or non-correspondence.

Here, a cluster ID, which is obtained by discretizing the above-described frequency spectrum as a feature quantity, can be set as the teacher data, and a main predictor can be extracted by making the decision tree model compact. However, for the sake of simplicity, the discretization processing may be omitted in generating a decision tree model for classifying observation time-series data.

### (Step S403)

With respect to a distribution data type and observation data, of a branch condition at each stage from a root to a leaf of the decision tree model TrM, the data selection ordinal number calculation unit 242 may give a guide value having a larger weight to a higher-rank branch. Preferably, an impurity decrement of data before and after classification at an intermediate node of the decision tree model, which is known as the Gini coefficient of the decision tree model, may be used as the guide value, or similarly an entropy decrement of a branch at the intermediate node may be used as the guide value. For data types that are branch conditions at a plurality of intermediate nodes, the guide value may be subjected to weighted addition.

The data selection ordinal number calculation unit 242 totals up the impurity decrements of data, which are caused by division, for all predictors (variables), and considers a value obtained by dividing the sum by the number of branch nodes, as an importance degree of the predictors (variables) in a learned tree. When the entropy decrement is used as a guide value in determination of a predictor used for a branch, the data selection ordinal number calculation unit 242 totals up entropy decrements, and considers a value obtained by dividing the sum by the number of branch nodes as an importance degree of the predictors (variables) in a learned tree.

The data selection ordinal number calculation unit 242 assigns ordinal numbers to be used for selection of data to each of the data types, in descending order of importance degree of the predictors. Alternatively, the data selection ordinal number calculation unit 242 may assign ordinal numbers in an order of branches of a learned tree (in an order of predictors surrounded in the predictor display 801, the predictor display 802, the predictor display 803, and the predictor display 804 in the example of FIG. 8, or in a case where the branches are of the same level, a branch whose number of pieces of observation time-series data to be classified is large is prioritized).

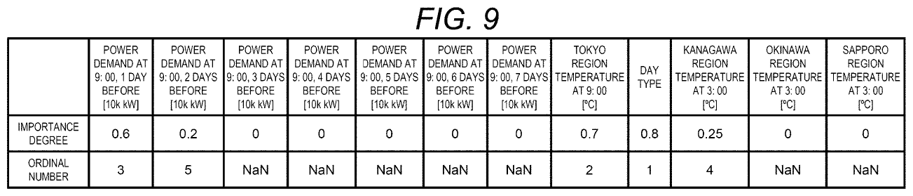

FIG. 9 is a diagram illustrating an example of a table in which importance degrees and ordinal numbers of predictors are stored.

### (Step S404)

The data and index selection unit 243 determines a predictor of a branch condition of the decision tree model TrM and a value thereof, as data for selecting distribution data and observation data to be added to data used for identification of a prediction model to be described later. That is, the data and index selection unit 243 determines a data type list sM indicating types of the distribution data, and an index list sT indicating a set of indexes for the data. The data type list sM is a set indicating a type selected from the M types of distribution data stored in the distribution data storage unit 222.

In the following description, “power demand at 9:00” is taken as a prediction target, and as standard setting of types of distribution data to be used for identification of a prediction model to be described later, “power demand at 9:00, one day before”, “power demand at 9:00, 1 days before”, “power demand at 9:00, 2 days before”, “power demand at 9:00, 3 days before”, “power demand at 9:00, 4 days before”, “power demand at 9:00, 5 days before”, “power demand at 9:00, 6 days before”, “power demand at 9:00, 7 days before”, “Tokyo region temperature at 9:00” and “day type” are set.

Regarding the temperature, in a learning process, an actual temperature may be used instead of a forecast temperature. In addition, with respect to observation data to be used as sample data, standard setting is performed to select observation data in the latest 30 days from all the observation data. Data of rare frequency event is added to the data (standard setting data) selected based on the standard setting, and the obtained data is set as training data used for identification of the prediction model.

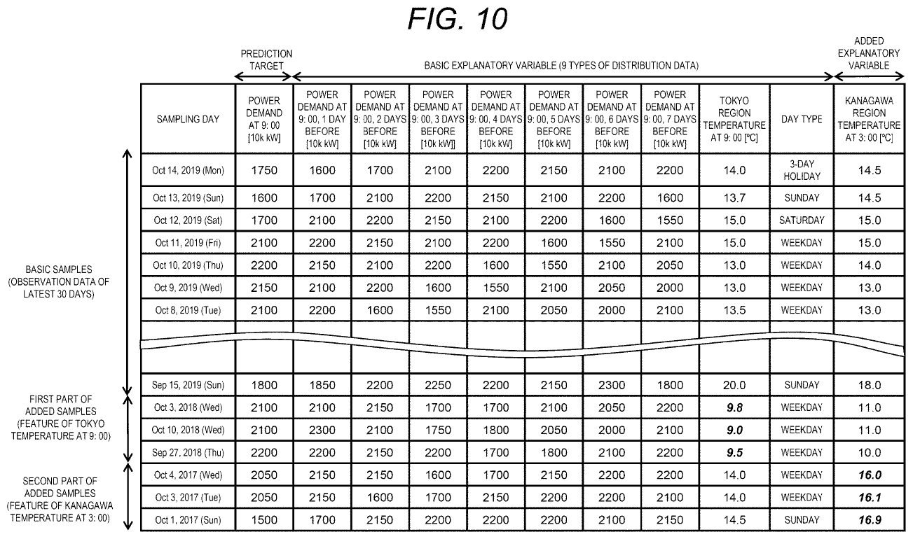

Details of the processing in step S404 will be described with reference to a flowchart of FIG. 6 and an example of a table (training data table 1000) of FIG. 10 in which training data used for identification of the prediction model is held.

FIG. 6 is a diagram illustrating an example of a flowchart relating to processing (data and index selection processing) performed by the data and index selection unit 243.

### (Step S601)

The data and index selection unit 243 reads a data type x of a predictor of the first ordinal number.

### (Step S602)

The data and index selection unit 243 determines whether or not the data type x has been selected among data types of training data. The data and index selection unit 243 moves the processing to step S603 if it is determined that the data type x has been selected, and moves the processing to step S604 if it is determined that the data type x has not been selected.

### (Step S603)

The data and index selection unit 243 reads a data type of a predictor of the next ordinal number, and returns the processing to step S602.

### (Step S604)

The data and index selection unit 243 adds the selected data type x to a data type list sM in order to designate an item to be held in the training data table 1000. In the example of FIG. 10, a data type of “Kanagawa region temperature at 3:00” is added to the data type list sM that designates a data type of the training data table 1000.

### (Step S605)

The data and index selection unit 243 pre-searches stored data for each of the data types held in the training data table 1000. More specifically, the data and index selection unit 243 searches the data storage device 111 for a forecast value (prediction input x*(t)) at a time point t of a prediction target, for each predictor of the data types designated in the training data table 1000.

For example, the data and index selection unit 243 searches for “Tokyo region temperature at 9:00” to obtain a search result (forecast value) such as “9° C.”. The data and index selection unit 243 refers to a condition value (for example, for “Tokyo region temperature at 9:00” of a predictor whose ordinal number is “2” as illustrated in FIG. 9, the condition value is “14° C. or higher/lower than 14° C.” and “10° C. or higher/lower than 10° C.” as in the frames of condition display 812 and condition display 813 in the example illustrated in FIG. 8) that is a value of a branch of the decision tree model TrM, and checks whether a sample (observation time-series data) corresponding to a prediction input x*(t) (here, “10° C.” which is a condition closest to prediction input x*(t)>prediction input x*(t) “9° C.”) is included in a basic sample (standard setting data) of the training data table 1000.

When the sample is not included in the basic sample, the data and index selection unit 243 acquires index information of the observation time-series data classified into a subtree ahead of the branch of the decision tree model TrM, and adds the index information to an index list sT of the observation time-series data so as to become an additional sample (selected data) of the training data. For example, in the example illustrated in FIG. 8, information (for example, a sampling date) indicating a sample whose “day type” is “other than 3-day holiday” and “Tokyo region temperature at 9:00” is “9° C. or higher and less than 10° C.” is added to the index list sT.

For example, the data and index selection unit 243 searches for “Kanagawa region temperature at 3:00” to obtain a search result (forecast value) such as “17° C.”. The data and index selection unit 243 refers to a condition value (for example, for “Kanagawa region temperature at 3:00” of a predictor whose ordinal number is “4” as illustrated in FIG. 9, the condition value is “16° C. or higher/lower than 16° C.” and “12° C. or higher/lower than 12° C.” as in the frames of condition display 813 and condition display 814 in the example illustrated in FIG. 8) that is a value of a branch of the decision tree model TrM, and checks whether a sample corresponding to a prediction input x*(t) (here, 16° C. which is a condition closest to prediction input x*(t) prediction input x*(t) “9° C.”) is included in a basic sample of the training data table 1000.

When the sample is not included in the basic sample, the data and index selection unit 243 acquires index information of the observation time-series data classified into a subtree ahead of the branch of the decision tree model TrM, and adds the index information to an index list sT of the observation time-series data so as to become an additional sample (selected data) of the training data. For example, in the example illustrated in FIG. 8, information (for example, a sampling date) indicating a sample whose “day type” is “other than 3-day holiday”, “Tokyo region temperature at 9:00” is “14° C. or higher” and “Kanagawa region temperature at 3:00” is “16° C. or higher and less than 17° C.” is added to the index list sT.

In the example illustrated in FIG. 10, the information on the sampling date is used as the index information, and sampling dates “Oct. 3, 2018” (Wed), “Oct. 10, 2018 (Wed)”, and “Sep. 27, 2018 (Thu)” of the observation time-series data classified into the subtree of the decision tree model TrM, on which “Tokyo region temperature at 9:00” corresponds to a forecast value of “9° C.”, are added to the index list sT. In addition, sampling dates “Oct. 4, 2017 (Wed)”, “Oct. 3, 2017 (Tue)” and “Oct. 1, 2017 (Sun), on which “Kanagawa region temperature at 3:00” corresponds to a forecast value of “17° C.”, are added to the index list sT.

As described above, in step S605, the index list sT is generated such that data lacking in the standard setting data is added based on a forecast value of a data type of the standard setting data. Further, in step S605, based on the generated decision tree model, a data type that is not the data type of the standard setting data is added to the data type list sM, and with respect to the added data type, an index list sT is generated such that data lacking in the standard setting data is added based on a forecast value of the added data type.

### (Step S606)

In addition of the data type and the data index, the data and index selection unit 243 determines whether or not the number of pieces of training data is equal to or less than an upper limit number NN (for example, 8000 pieces). When it is determined that the number of pieces of training data is the upper limit number NN, the data and index selection unit 243 returns the process to step S603, and generates a data type list sM and an index list sT, for the selected data whose number of pieces is up to a planned upper limit.

Preferably, the upper limit number NN of the training data may take a form of being changeable as a parameter, and may have a small value (for example, 500) as an initial value and be increased in a range where decrease of an error evaluation value delta of the error evaluation unit 247 to be described later continues. Thus, the identification of the prediction model by the necessary and sufficient training data is executed.

### (Step S405)

The selected data transfer processing unit 244 selects data of “input” and “output” as selected data at least in accordance with the data type list sM and the index list sT of the selected data, and acquires the selected data from the data storage device 111 via the communication device 234 and the communication device 214. In addition to the index list sT, a period such as the latest two weeks is set as a period of data to be used in a standard manner (standard setting data) and is set as a data index, and data of the corresponding index is acquired from the data storage device 111.

### (Step S406)

The prediction model identification unit 245 identifies a prediction model for calculating a prediction value of the prediction target, by using the above-described selected data and standard setting data (xi, yi) [i∈sM×(sT∪sTs)] (a set of this group of data is referred to as training data). With respect to identification of the prediction model, for example, in a case where data taken as explanatory variables has two types of x1 and x2, and in a case where the prediction model is a multiple regression model of a multivariable regression model, the prediction model is given by the following formula (1).

y*=a×x1+b×x2+c Formula (1)

y*: objective variable

a, b: partial regression coefficient

c: constant term (intercept)

x1, x2: explanatory variable

The prediction model of a prediction target is not limited to the above-described model, and other known methods may be applied. The known methods are exemplified below. For example, a method of assuming linearity, including a linear regression model such as a multiple regression model, and a generalized linear model such as a logistic regression; a method of assuming autoregressiveness, such as an auto regressive with exogenous (ARX) model; a method of using reduced estimator, such as Ridge regression, Lasso regression, and ElasticNet; a method of using dimensional reducer, such as partial least squares method and principal component regression; and a method called non-parametric such as nonlinear model using polynomial, support vector regression, regression tree, Gaussian process regression, and neural net. Preferably, the prediction can be achieved with high accuracy by applying an algorithm (kernel function prediction method) using a kernel function including Gaussian process regression by regression from data of an approximate output of the Gaussian process. The prediction model identification unit 245 of the present embodiment outputs an identified Gaussian process regression model GpM (Gauss Pseudo-spectral Method).

Note that, in general, a random variable is a variable whose value is determined by a result of a random trial, while a set {X (t)|t∈T} of random variables indexed by a parameter set T is called a stochastic process. When T represents time, the stochastic process is a sequence of values that change randomly in accordance with the passage of time.

However, in the present embodiment, T is not limited to a set indicating time. Here, t E T may be an index that specifies data, with respect to input data and output data (observation data or distribution data of the prediction target). For example, it may be a region index or a spatial coordinate index, a time point index, a group number index for the region index and the time point index, a measuring instrument index that specifies each data observation device, an index z (z∈Z, Z={t|X (t)⊆Y}) indicating that a value x of prediction target is in a specific range, or a predictor indicating branch information of a tree structure for classifying values of prediction target.

### (Step S407)

The first prediction processing unit 246 of the analysis prediction calculation device 112 calculates an output y*, which is a prediction value of a prediction target, by using an input x* of future data such as a future temperature, an input x of past distribution data and the Gaussian process regression model GpM.

Note that an output y of a past prediction target and an output y* of prediction performed in the past may be included in the data to be taken as the input x. For example, a demand value y (t12) at 12:00 of a day before the day on which prediction is to be executed is taken as one of the elements of the input x (x is a vector).

The prediction means that, for example, values of elements x1* and x2* of the input x* are substituted into x1 and x2 respectively in Formula (1) and a value of y is calculated and output as the output y*.

### (Step S408)

The analysis prediction calculation device 112 uses the second prediction processing unit 248 to calculate an output y˜, which is a second prediction value of a prediction target, by using the decision tree model TrM, an input x* of future data such as a future temperature and/or an input x of past distribution data, and observation data y that is an output of a past prediction target. For example, the analysis prediction calculation device 112 sequentially determines branch conditions of a decision tree using the distribution data and the observation data, and performs prediction. Further, when a value of a branch condition is not determined, the analysis prediction calculation device 112 performs a prediction calculation, which is known as a Bayes optimal prediction algorithm based on a decision tree model.

### (Step S409)

The analysis prediction calculation device 112 may use the error evaluation unit 247 to select data in the observation data storage unit 221 and the distribution data storage unit 222 by a predetermined plurality of sets (for example, 20 sets) by using a random number, try to perform prediction based on that data, and output, as an error evaluation value, an average value of prediction errors obtained by comparing a prediction result thereof with an actual past output y of a prediction target.

### (Step S410)

The superposition processing unit 249 outputs a graph (superimposition graph) obtained by superimposing information related to the output y* of the first prediction processing unit 246 on information related to the output y˜ of the second prediction processing unit 248.

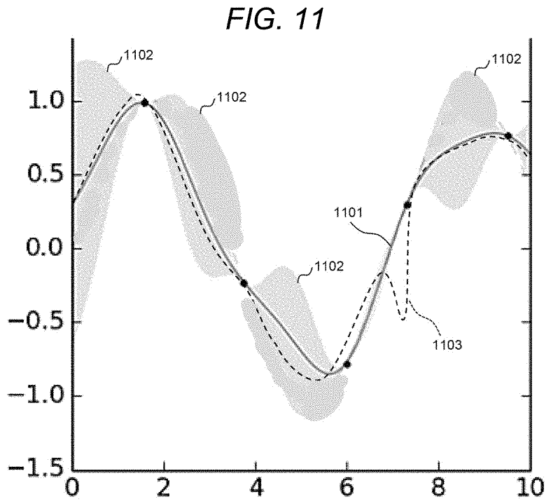

FIG. 11 is a diagram illustrating an example of a superimposition graph. The horizontal axis represents time and “0” represents the current time, and prediction time of 10 hours ahead is exemplified. The vertical axis indicates an output value of a prediction target which is normalized so as to take a value from “−1” to “1”. The value of the output y* of the first prediction processing which is indicated by 1101 (solid line), and a width of 90% prediction interval by the Gaussian process regression for the prediction target, which is indicated by 1102, are output. Further, a value of the output y˜ of the second prediction processing, which is indicated by 1103 (dotted line), is output.

In general, a stochastic process means a random variable that changes over time, and a Gaussian process is one type of stochastic process of continuous time. When a linear combination made by randomly selecting (finite number of) Xt1, . . . , Xtk from a stochastic process {Xt} t∈T follows a normal distribution, {Xt} t∈is called a Gaussian process.

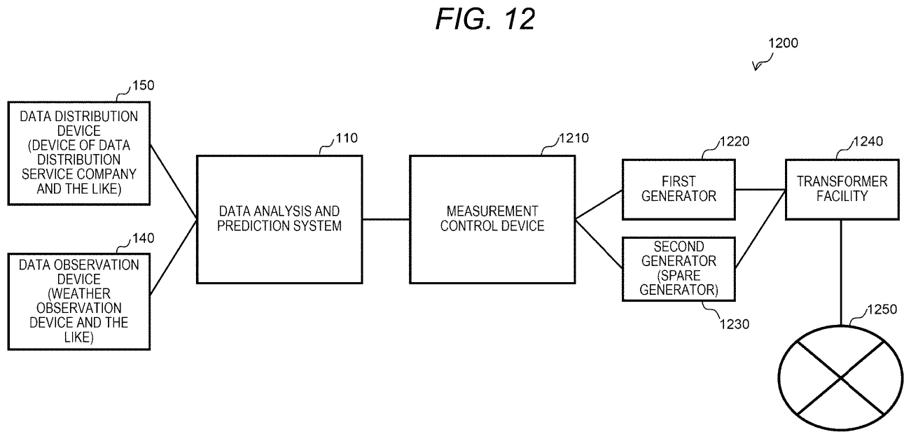

FIG. 12 is a diagram illustrating a configuration example of a power generation and storage prediction control system 1200 using a data prediction method.

The data analysis and prediction system 110 outputs a prediction value for a 4-hour-after power demand. A measurement control device 1210 measures a current power generation output of a first generator 1220 that is normally used, and a output change speed thereof, which is a possible change amount during 4 hours of power generation output, and performs prediction control for commanding activation of a spare generator (for example, second power generator 1230) when a power generation capacity for satisfying the 4-hour-after demand is insufficient. The power generated by the first generator 1220 and the second generator 1230 is boosted by a transformer facility 1240, and is transmitted via a power transmission network 1250.

### (Overview)

The data analysis and prediction system 110 may be summarized as follows.

[1] The data analysis and prediction system 110 includes a structure analysis unit that predicts (classifies) data of a prediction target (or prediction output, prediction value, prediction data, output data, and output) by using a structure of a decision tree model using explanatory variables (or predictor, input data, and output). Further, the data analysis and prediction system 110 includes a data selection unit that analyzes data of a long period (one year to two years), and determines conditions such as a type of data necessary for prediction and a sampling time point and location of data. Preferably, the data analysis and prediction system 110 includes a variable and index determination unit that determines indexes for a type of explanatory variable and a period and location added to the explanatory variable, in the prediction processing, based on the output of the structure analysis unit.
[2] The data analysis and prediction system 110 includes a kernel function prediction unit that uses the data selected by the data selection unit to identify and predict a prediction model that uses the kernel function.
[3] The data analysis and prediction system 110 preferably includes a prediction unit that is based on a decision tree model.
[4] The data analysis and prediction system 110 preferably includes a prediction display unit that displays information on a prediction output based on the kernel function and information on a prediction output based on the decision tree model.

### Effects of Present Embodiment

Not only a memory is required in proportion to a number M of types of sample data adopted as training data in statistical machine learning using a kernel function, but also a memory and a calculation amount are required in proportional to the square of a number K of samples used. In one example, in order to handle five-minute data for one year which is generated from measuring instrument signals, n=105120, and approximately 800 terabytes of memory is required. Therefore, ad hoc selection of sample data is performed, that is, the sample data is limited to the latest period, which hinders highly accurate prediction.

In an example of application of the invention, based on sample data of power generation market settlement price, an occurrence of off-shore waiting time (waiting time of waiting at sea for unloading of transportation fuel) exceeding a normal reference value for a tanker and an occurrence of the amount of solar radiation exceeding an annual average are subjected to structure analysis as predictors of a higher-rank ordinal number, and indexes of sample data corresponding to these occurrences are added to a selected index set and automatically transferred to a K x K statistic analysis processing unit of an analysis and prediction device.

According to the present system, by structure analysis (that is, generation of a decision tree model) of the sample data over a long period (in one example, two years), ordinal numbers can be given to the predictors (conditional branches in the structure analysis), and sample data for which the predictor has a significant value can be added, related to an item i type (i E M) of input data corresponding to a predictor with a higher-rank ordinal number. Compared with virtual prediction using all the samples (the number of samples N), the memory amount and the calculation amount can be reduced in proportion to the square of K (reduction amount=N²−K²), and highly accurate prediction can be realized which incorporates a causal relationship that is lacking in the sample data in the latest period.

Further, as illustrated in FIG. 11, in the second prediction processing in which the memory constraint is relaxed, a result of prediction using sample data of one year to two years and a prediction result of the first prediction processing and a calculation result of a prediction interval are output so as to be able to be compared with each other, and thus a supplementary effect is exhibited. For example, when there is no large difference in the prediction results or there is a difference in the prediction results, that overlearning occurs due to deviation in the sample data for identification of prediction model (for example, a width of the prediction interval is small, but there is a difference between two prediction values), and that the sample data is insufficient (the width of the prediction interval is large, but there is difference in the prediction values and it is not steady), can be utilized by a user as support information to be determined by the user himself/herself.

The above is the description of the effect of being able to reduce the explanation of the prediction value and the error of the prediction value by the data analysis and prediction system of the present embodiment.

In the background where the data analysis and prediction system is found to be beneficial, there is a recent social environment in which emergency power interchange is difficult, a cause of which is that there is also a change in a power supply system including separation of electrical power generation from power distribution and transmission. That is, in an electric power company, an actual situation of the company for the three businesses of power generation, power transmission and distribution, and electric power sale has been divided into three in recent years, whereas in the past it was easy to perform control quickly with a single management.

According to this example, there is a circumstance where quick control for emergency electric power interchange is difficult due to separation of electrical power generation from power distribution and transmission like the three divisions, and the cost directly increases. On the other hand, the present data analysis and prediction system realizes highly accurate power demand prediction capable of predicting and reducing emergency power interchange, thereby making contributions to society.

Further, in the background where the data analysis and prediction system is found to be beneficial, thanks to the high integration of computer integrated circuits in recent years, the prediction by various regression models instead of theoretical formulas can correspond to processing time in actual work; on the other hand, with regressions where theoretical formulas and structural models are not specified, there is no means for confirming whether interpolation or extrapolation of data suitable for emergency is performed, and it is not suitable for abnormal processing in actual work. On the other hand, the present data analysis and prediction system reads a predictor that is input data arranged in a forward order in a tree structure, so as to allow the user to confirm a stage until determination of the prediction value, thereby realizing appropriate business execution based on the prediction value for the user and making contributions to society.

### (2) APPENDIX

The embodiment described above includes, for example, the following contents.

Although a case where the invention is applied to a data processing system is described in the embodiment described above, the invention is not limited thereto, and can be widely applied to various other systems, devices, methods, and programs.

In the above-described embodiment, the functions (the observation data storage unit 221, the distribution data storage unit 222, and the like) of the data storage device 111 may be implemented by the CPU 211 reading a program (software) stored in a ROM into a RAM and executing the program, may be implemented by hardware such as a dedicated circuit, or may be implemented by a combination of software and hardware, for example. A part of the functions of the data storage device 111 may be implemented by another computer capable of communicating with the data storage device 111.

In the above-described embodiment, the functions (decision tree model generation unit 241, data selection ordinal number calculation unit 242, data and index selection unit 243, selected data transfer processing unit 244, prediction model identification unit 245, first prediction processing unit 246, and the like) of the analysis prediction calculation device 112 may be implemented by a CPU reading a program (software) stored in a ROM into a RAM and executing the program, may be implemented by hardware such as a dedicated circuit, or may be implemented by a combination of software and hardware, for example. Apart of the functions of the analysis prediction calculation device 112 may be implemented by another computer capable of communicating with the analysis prediction calculation device 112.

Further, in the above-described embodiment, the configuration of each table is an example, and one table may be divided into two or more tables, or all or a part of the two or more tables may be one table.

Further, although various types of data are described using the XX table in the above-described embodiment, the data structure is not limited and may be represented as XX information or the like.

In the above description, information such as a program, a table, and a file for implementing functions can be stored in a storage device such as a memory, a hard disk, or a solid state drive (SSD), or can be stored in a recording medium such as an IC card, an SD card, or a DVD.

The above-described embodiment has, for example, the following characteristic configuration.

A data processing system (for example, the data processing system 100, the data analysis and prediction system 110) that performs prediction using a prediction model (for example, a prediction model of a method of assuming linearity, a method of assuming autoregressiveness, a method of using reduced estimator, a method of using dimensional reducer, a method called non-parametric, or a method using a kernel function), includes a selection unit (for example, the analysis prediction calculation device 112, the data and index selection unit 243, and the selected data transfer processing unit 244) that selects data to be used for identification of the prediction model from a storage unit (for example, the storage device 235, the analysis prediction calculation device 112, the storage device 215, the data storage device 111, the data observation device 140 and the data distribution device 150) that stores data, and a processing unit (for example, the analysis prediction calculation device 112 and the prediction model identification unit 245) that uses data selected by the selection unit to identify the prediction model. The selection unit selects, from the storage unit, predetermined first data (for example, data of a predetermined period, standard setting data), and second data (for example, selected data) of a type (for example, data type) and/or condition (for example, a value of a branch condition) different from the first data, based on a branch condition of structure data of a structural prediction model.

With the above configuration, for example, the predetermined first data, and the second data of a type and/or condition different from the first data, are used for identification of the prediction model, and highly accurate prediction is realized which incorporates a causal relationship that is lacking in the predetermined first data. With the above configuration, since it is possible to avoid a situation where data of a rare frequency event is missing from the data used for identification of the prediction model, it is possible to reduce consumption of the memory and improve accuracy of prediction, for example, by adopting a prediction model using the kernel function to shorten a sampling period.

There are provided a generation unit (for example, the analysis prediction calculation device 112, the decision tree model generation unit 241) that uses the data stored in the storage unit as structure data of the structural prediction model to generate a decision tree model that appears at a higher rank as a predictor that is a branch condition for dominantly determining a prediction target (for example, energy consumption data for power, gas, water and the like, data of energy production amount by solar power generation, wind power generation and the like, and a transaction amount of energy and a power generation market settlement price that are traded at Japan Electric Power Exchange (JEPX)), and an assignment unit (for example, the analysis prediction calculation device 112, the data selection ordinal number calculation unit 242) that assigns an ordinal number to be used for selection of data in the selection unit to a predictor in the decision tree model generated by the generation unit. The selection unit selects the second data from the storage unit until a predetermined number (for example, the upper limit number NN) is reached according to the ordinal number assigned by the assignment unit.

With the above configuration, by generating the decision tree, the ordinal number is assigned to the predictor, and data for which the predictor with a higher-rank ordinal number has a significant value is selected. For example, in a case where identification of the prediction model using a kernel function is performed, the memory amount and the calculation amount are reduced (reduction amount=N²−K²) in proportion to the square of a sum (K) of the number of pieces of the first data and the number of pieces of the second data, as compared with the virtual prediction using all the data (N).

Here, a predictor (explanatory variable) relating to a rare frequency event has a relatively high importance degree. Therefore, for example, when the ordinal number is given in descending order of importance degree of the predictors, even if the sampling period (predetermined period) is shortened, the second data for which a predictor with a higher-rank ordinal number has a significant value is used in the identification of the prediction model, and thus it is possible to avoid a situation where data of the rare frequency event is missing.

As described above, according to the above configuration, it is possible to reduce the consumption of the memory and avoid a situation where the data of the rare frequency event is missing from the data used for identification of the prediction model.

The prediction model is a prediction model using a kernel function.

With the above configuration, since the prediction using a kernel function is performed, highly accurate prediction is realized as compared with multiple regression prediction and Bayes optimal prediction using a decision tree model.

Further, there are provided a second processing unit (for example, the analysis prediction calculation device 112, the second processing unit 248) that performs prediction using the decision tree model that is generated by the generation unit using the data stored in the storage unit, and an output unit (for example, the analysis prediction calculation device 112, the superimposition processing unit 249) that performs outputting. The processing unit (for example, the first prediction processing unit 246) performs prediction using the prediction model, and the output unit outputs a prediction result of the processing unit and a prediction result of the second processing unit.

The output unit may display the prediction result of the processing unit and the prediction result of the second processing unit on the information input/output terminal 120, may transmit the prediction results as a file to the information input/output terminal 120, may print the prediction results using the output device 233, or may output the prediction results in other forms.

With the above configuration, since the prediction result of the processing unit and the prediction result of the second processing unit are output, the user can confirm that there is no large difference in the prediction results, for example, when these results are displayed in a superimposed manner. Further, when there is a difference in the prediction results, the user can confirm that overlearning has occurred due to deviation of the selected data or that the selected data is insufficient.

In addition, the above configuration may be modified, rearranged, combined, or omitted as appropriate without departing from the scope of the invention.

It should be understood that items included in a list in the form of “at least one of A, B, and C” can mean “A”, “B”, “C”, “A and B”, “A and C”, “B and C” or “A, B, and C”. Similarly, items listed in the form of “at least one of A, B, or C” can mean “A”, “B”, “C”, “A and B”, “A and C”, “B and C” or “A, B, and C”.

What is claimed is:

1. A data processing system that performs prediction with a prediction model, comprising:
a selection unit configured to select data to be used for identification of the prediction model from a storage unit that stores data; and
a processing unit configured to identify the prediction model by using the data selected by the selection unit,
wherein the selection unit selects, from the storage unit, predetermined first data, and second data of a type and/or condition different from the first data, based on a branch condition of structure data of a structural prediction model.

2. The data processing system according to claim 1, further comprising:
a generation unit configured to generate, using the data stored in the storage unit, a decision tree model in which a predictor that is a branch condition which is more dominant to determine a prediction target appears at a higher rank, as the structure data of the structural prediction model; and
an assignment unit configured to assign an ordinal number to be used for selection of data in the selection unit to a predictor in the decision tree model generated by the generation unit,
wherein the selection unit selects the second data from the storage unit until a predetermined number is reached according to the ordinal number assigned by the assignment unit.

3. The data processing system according to claim 1,
wherein the prediction model is a prediction model using a kernel function.

4. The data processing system according to claim 2, further comprising:
a second processing unit configured to perform prediction using the decision tree model that is generated by the generation unit using the data stored in the storage unit; and
an output unit configured to perform outputting,
wherein the processing unit performs prediction using the prediction model, and
wherein the output unit outputs a prediction result of the processing unit and a prediction result of the second processing unit.

5. A data processing method for a data processing system that performs prediction using a prediction model, the method comprising:
selecting, by a selection unit, data to be used for identification of the prediction model from a storage unit that stores data; and
identifying, by a processing unit, the prediction model by using the data selected by the selection unit,
wherein the selection unit selects, from the storage unit, predetermined first data, and second data of a type and/or condition different from the first data, based on a branch condition of structure data of a structural prediction model.
